(19) United States
(12) Patent Application Publication
(10) Pub. No.: US 2015/0062367 A1
(43) Pub. Date: Mar. 5, 2015

(54) IMAGE CAPTURING APPARATUS AND CAMERA

(71) Applicant: CANON KABUSHIKI KAISHA, Tokyo (JP)

(72) Inventor: Fumihiro Inui, Yokohama-shi (JP)

(21) Appl. No.: 14/456,063

(22) Filed: Aug. 11, 2014

(30) Foreign Application Priority Data
Sep. 3, 2013 (JP) 2013-182475

(51) Int. Cl. H04N 5/369; H04N 5/232

(52) U.S. Cl. CPC H04N 5/3698; H04N 5/23229
USPC 348/222.1; 348/302

(57) ABSTRACT

An image capturing apparatus, comprising a pixel array in a semiconductor region, a pad portion for receiving a voltage, a plurality of first power wiring patterns arranged on the pixel array along a first direction as one direction of a row direction and a column direction, a second power wiring pattern, arranged on a region outside the pixel array along a second direction as the other direction of the row direction and the column direction, for electrically connecting the plurality of first wiring patterns to the pad portion, and a plurality of contacts for electrically connecting the plurality of first power wiring patterns to the semiconductor region, wherein a resistance value of the second power wiring pattern in the second direction is smaller than a resistance value of the plurality of first power wiring patterns in the first direction.

### BACKGROUND OF THE INVENTION

1. Field of the Invention

The present invention relates to an image capturing apparatus and a camera.

2. Description of the Related Art

An image capturing apparatus can include a pixel array provided on a substrate. If the potential distribution on the substrate is not uniform, since shading can occur, shading correction processing can be performed for image data.

Japanese Patent Laid-Open No. 2001-230400 discloses a structure in which contacts for providing potentials to a well in a substrate are arranged on the respective pixels (or periodically) in a pixel region so as to make the potential distribution of the well uniform. The structure disclosed in Japanese Patent Laid-Open No. 2001-230400 reduces shading originating from the potential distribution.

In order to make the above potential distribution uniform, it is necessary to arrange a considerable number of contacts described above. This leads to a reduction in the area of each photoelectric conversion unit.

### SUMMARY OF THE INVENTION

The present invention is advantageous in facilitating shading correction processing while reducing the number of contacts.

One of the aspects of the present invention provides an image capturing apparatus, comprising a pixel array including a plurality of pixels arranged in a semiconductor region, a pad portion configured to receive a reference voltage, a plurality of first power wiring patterns, each being arranged on the pixel array along a first direction which is one selected from a row direction and a column direction of the pixel array, a second power wiring pattern arranged on a region outside the pixel array along a second direction which is the other direction of the row direction and the column direction of the pixel array and configured to electrically connect the plurality of first wiring patterns respectively to the pad portion, and a plurality of contacts configured to electrically connect the plurality of first power wiring patterns to the semiconductor region, wherein a resistance value of the second power wiring pattern in the second direction is smaller than a resistance value of each of the plurality of first power wiring patterns in the first direction.

Further features of the present invention will become apparent from the following description of exemplary embodiments with reference to the attached drawings.

### BRIEF DESCRIPTION OF THE DRAWINGS

FIG. 1 is a schematic view for explaining an example of the arrangement of an image capturing apparatus;

FIG. 2 is a schematic view for explaining an example of the sectional structure of the image capturing apparatus;

FIG. 3 is a circuit diagram for explaining an example of the circuit configuration of a pixel;

FIG. 4 is a view for explaining the resistive components of power wiring patterns;

FIG. 5 is a view for explaining the resistive components of the power wiring patterns;

FIG. 6 is a schematic view for explaining another example of the arrangement of the image capturing apparatus;

FIG. 7 is a schematic view for explaining still another example of the arrangement of the image capturing apparatus;

FIG. 8 is a schematic view for explaining still another example of the arrangement of the image capturing apparatus; and

FIG. 9 is a block diagram for explaining an example of the arrangement of an image capturing system.

### DESCRIPTION OF THE EMBODIMENTS

### First Embodiment

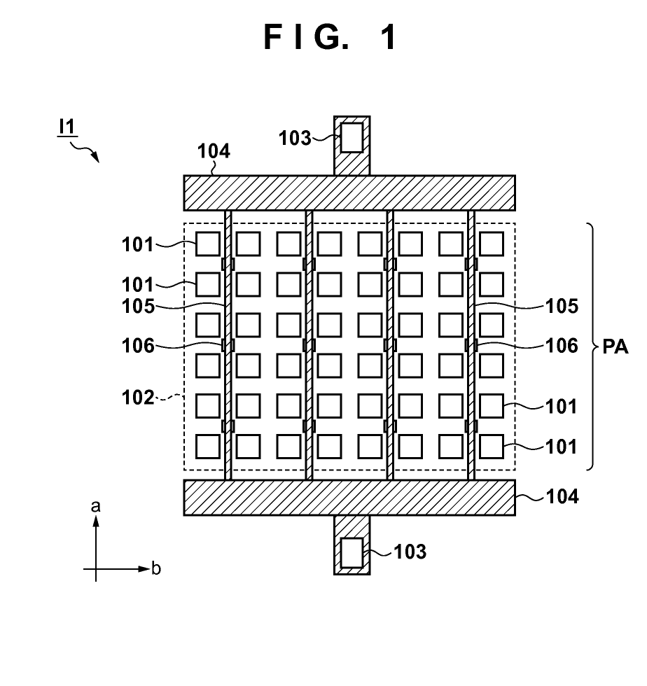

An image capturing apparatus I1 of the first embodiment will be described with reference to FIGS. 1 to 5. As exemplified by FIG. 1, the image capturing apparatus I1 includes a pixel array PA, bonding pads 103, a plurality of first power wiring patterns 105, second power wiring patterns 104, and a plurality of contacts 106.

The pixel array PA can be formed by arraying a plurality of pixels 101. The pixels 101 are provided on, for example, a well 102 (for example, a p-type semiconductor region) provided in a semiconductor substrate so as to form a plurality of rows and a plurality of columns. For the sake of descriptive convenience, FIG. 1 shows the pixel array PA of 6 rows×8 columns.

The bonding pad 103 is a pad portion for receiving a reference voltage. In this case, the bonding pads 103 (two in total) are respectively provided on the upper and lower sides of the pixel array PA. The plurality of power wiring patterns 105 are arranged along the a direction (first direction) above the pixel array PA. In the following description, the a direction is, for example, the column direction of the pixel array PA. In addition, the power wiring patterns 104 are arranged along the b direction (second direction) above regions outside the pixel array PA. In the following description, the b direction is, for example, the row direction of the pixel array PA. The power wiring patterns 104 electrically connect the respective power wiring patterns 105 to the bonding pads 103. In addition, the plurality of contacts 106 electrically connect the respective power wiring patterns 105 to the well 102. Although the power wiring patterns 104 and the power wiring patterns 105 are distinctly described for the sake of convenience, the power wiring patterns 104 and 105 may be integrally formed. For example, the power wiring patterns 104 and 105 may be arranged on the same wiring layer. In this case, the power wiring patterns 104 and 105 are formed from the same conductive material.

With the above arrangement, an externally input reference voltage (for example, 0 [V]) is supplied to the well 102 via the bonding pad 103.

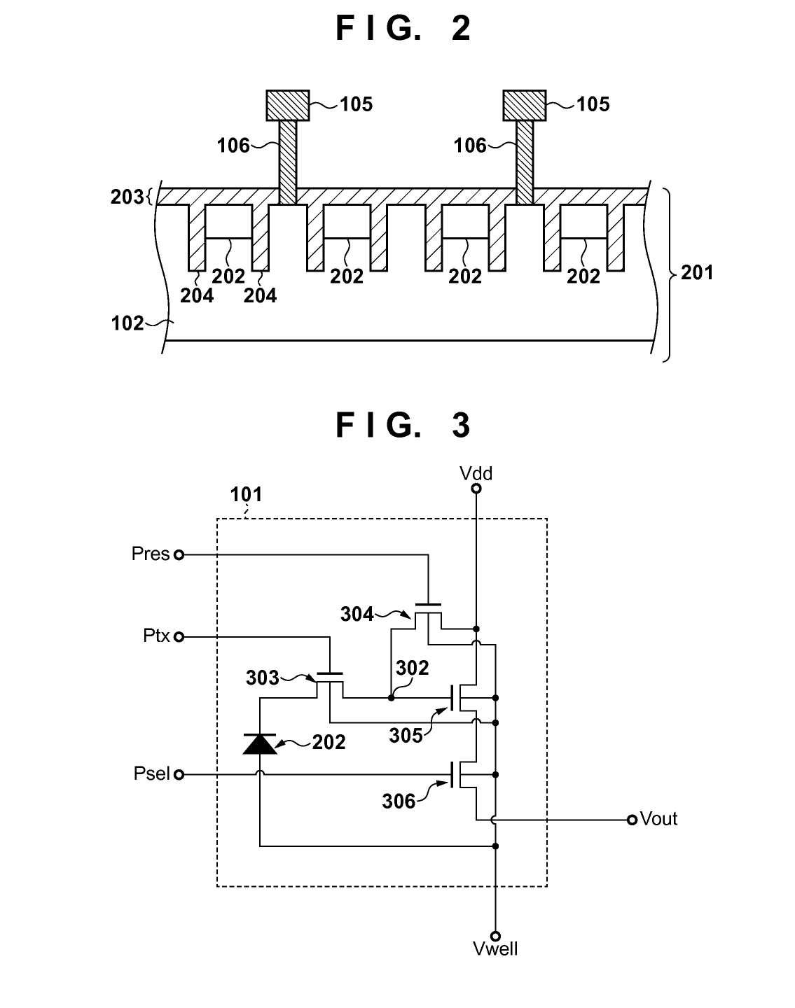

FIG. 2 is a schematic view showing the sectional structure of part of the pixel array PA of the image capturing apparatus I1. For example, the p-type well 102 is provided in the upper portion of an n-type semiconductor substrate 201. An oxide film 203 is formed on the surface of the substrate 201. In the well 102, photoelectric conversion units 202 (n-type semiconductor regions) are formed in correspondence with the respective pixels 101. The respective photoelectric conversion units 202 are divided by element isolation portions 204. Although not shown, the well 102 is provided with transistors for respectively reading out charges from the photoelectric conversion units 202 and outputting them as pixel signals.

The power wiring patterns 105 for supplying the reference voltage are arranged above the substrate 201. The contacts 106 electrically connect the power wiring patterns 105 to the well 102. This provides a potential to the well 102.

A metal material such as copper or aluminum can be used for the power wiring patterns 104 and 105. The well 102 formed from a semiconductor such as silicon has a resistivity 10² times higher than that of the power wiring patterns 104 and 105. For this reason, the plurality of power wiring patterns 105 may be arranged above the pixel array PA, and the reference voltage may be supplied at several positions on the well 102 via the contacts 106.

FIG. 3 shows an example of the circuit configuration of the unit pixel 101. The pixel 101 can include the photoelectric conversion unit 202 (for example, the photodiode), a transfer transistor 303, a floating diffusion 302, a reset transistor 304, a source follower transistor 305, and a selection transistor 306. A control signal Ptx is provided to the gate terminal of the transfer transistor 303. When the control signal Ptx is activated, the transfer transistor 303 transfers the charges generated and accumulated by the reception of light by the photoelectric conversion unit 202 to the floating diffusion 302. The source potential of the source follower transistor 305 changes in accordance with a fluctuation in the amount of charges transferred to the floating diffusion 302. A control signal Psel is provided to the gate terminal of the selection transistor 306. When the control signal Psel is activated, the selection transistor 306 can output an output Vout corresponding to the source potential of the source follower transistor 305 to a column signal line for reading out a pixel signal. Note that a control signal Pres is provided to the gate terminal of the reset transistor 304. When the control signal Pres is activated, the reset transistor 304 resets the potential of the floating diffusion 302. In this case, NMOS transistors are used for the respective transistors 303 and 304, and a reference voltage Vwell (for example, 0 [V]) is supplied to the back gate terminal of each of the transistors 303 and 304.

The image capturing apparatus I1 can include a driving unit (not shown) which drives the pixel array PA and a signal readout unit (not shown) which reads out the pixel signal output from each pixel 101 of the pixel array PA. The driving unit outputs each control signal described above to each pixel 101 via the control line arranged in the b direction (row direction) to drive the pixel array PA for each row. The signal readout unit reads out the pixel signal output from each pixel 101 for each column, and sequentially outputs the readout pixel signals outside the image capturing apparatus I1.

When performing the readout operation of reading out a pixel signal from each pixel 101, a potential fluctuation can occur in the well 102. This potential fluctuation can occur due the driving of the pixel 101, more specifically, for example, charge transfer from the photoelectric conversion unit 202 or capacitive coupling caused by the driving of each transistor. Since a nonuniform potential distribution caused by this potential fluctuation causes shading in the image obtained by using a pixel signal, it is preferable to make the potential distribution uniform.

The convergence time required for the above potential fluctuation to converge depends on the time constant between a capacitance value C including a well capacitance and a resistance value R of a power wiring pattern. Consider a CMOS image sensor with a unit pixel size of 6 μm×6 μm and 24,000,000 pixels (6000 rows×4000 columns) as a reference example. Assume that the wiring resistance value of the power wiring pattern is given as R_{EX}=12 [kΩ], the number of power wiring patterns is given as k=100, the capacitance of a unit pixel is given as C_{EX}=5 [fF], and the number of pixels to be simultaneously driven is given as m=6000 (corresponding to one row). In this case, a load τ per power wiring pattern is given as τ∞R_{EX}×C_{EX}×m/k=3.6 [nsec]. That is, in order to shorten the convergence time, it is preferable to increase the number k of power wiring patterns and decrease the wiring resistance value R_{EX} of each power wiring pattern. This can make the potential distribution uniform.

However, for example, in order to increase the number k of power wiring patterns to make a potential distribution uniform throughout the well 102, it is necessary to arrange a considerable number of contacts 106. This will increase the area of the pixel array PA, resulting in difficulty in ensuring an area for each photoelectric conversion unit 202.

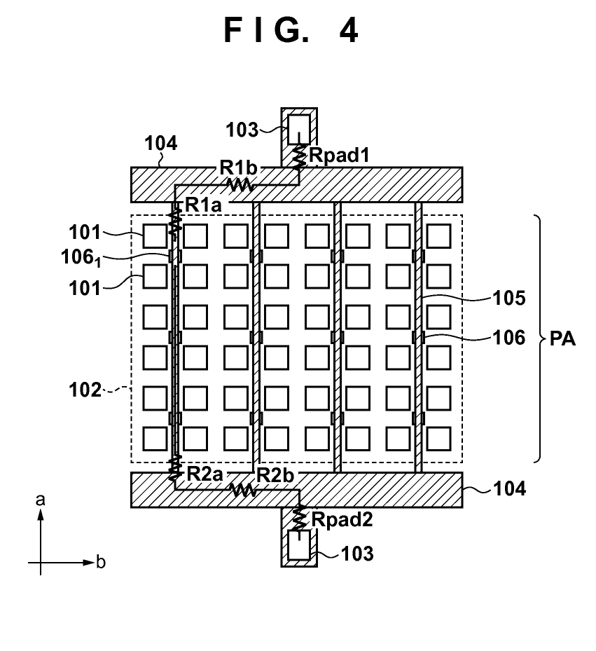

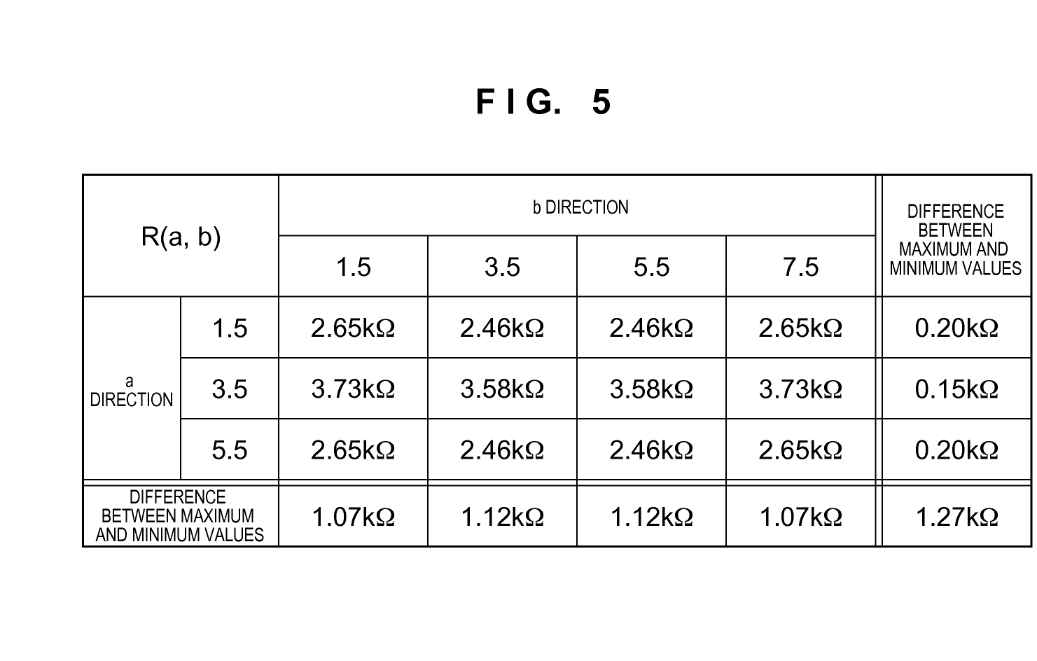

The wiring resistors of the power wiring patterns 104 and 105 for supplying the reference voltage to the well 102 will be described below with reference to FIGS. 4 and 5. FIG. 4 shows the power wiring patterns 104 and 105 of FIG. 1 with wiring resistors between a contact 106₁ and the bonding pads 103. The contact 106₁ is one of the contacts 106 which is arranged between the first and second rows and between the first and second columns in the pixel array PA. For the sake of convenience, the position of the contact 106₁ is represented by wct(1.5, 1.5). For example, the position of the contact 106 arranged between the fifth and sixth rows and between the seventh and eighth columns in the pixel array PA is represented by wct(5.5, 7.5).

A wiring resistor R1 between the contact 106₁ and one bonding pad 103 can be represented as R1=R1a+R1b+Rpad1. A resistive component R1a exists in the power wiring pattern 105 in the a direction. A resistive component R1b exists in the power wiring pattern 104 in the b direction. A resistive component Rpad1 exists between the power wiring pattern 104 and the bonding pad 103. Note that each resistive component is calculated by (sheet resistance [Ω/□] of wiring pattern)×(length L of wiring pattern)/(width W of wiring pattern).

In this case, there are a resistance value Rb_total of the power wiring pattern 104 (total length) in the b direction and a resistance value Ra_total of the power wiring pattern 105 (total length) in the a direction. In this case, R1a=Ra_total×(length of portion of power wiring pattern 105 which extends from contact 106₁ to power wiring patterns 104)/(total length of power wiring patterns 105). In addition, R1b=Rb_total×(length of portion of power wiring pattern 104 which extends from power wiring pattern 105 connected to contact 106₁ to bonding pad 103)/(total length of power wiring patterns 104).

Likewise, a wiring resistor R2 between the contact 106₁ and the other bonding pad 103 can be represented as R2=R2a+R2b+Rpad2. A combined resistance value R_{(1.5, 1.5)} of the power wiring patterns 104 and 105 corresponding to the contact 106₁ at a position wct(1.5, 1.5) can be represented as R_{(1.5, 1.5)}=R1∥R2.

FIG. 5 is a table showing the combined resistance value R of the power wiring patterns corresponding to each of contacts 106ₙ at positions wct(1.5, 1.5) to wct(5.5, 7.5), which is calculated in the above manner. For the sake of descriptive convenience, assume that Rpad1=Rpad2=0[Ω]. Assume also that the sheet resistance is 0.1 [Ω/□], the total length of the power wiring patterns 104 and 105 is 24 mm, the width of power wiring pattern 104 is 2 μm, and the width of the power wiring pattern 105 is 0.2 μm. That is, Ra_total=12[Ω], and Rb_total=1.2[Ω]. FIG. 5 indicates, for example, that the combined resistance value R of the power wiring patterns corresponding to the contact 106 at the position wct(3.5, 1.5) is 3.73 [kΩ].

FIG. 5 indicates that the difference between the maximum and minimum values of the combined resistance values R greatly changes depending on the combination of the contacts 106 as comparison targets. Referring to FIG. 5, if all the contacts 106 in the pixel array PA are targets, the difference between the maximum and minimum values of the combined resistance values R is 1.27 kΩ. If the contacts 106 of one group arranged in the a direction (that is, the contacts 106 of one group having the same coordinate indicating a position in the b direction) are targets, the difference between the maximum and minimum values of the combined resistance values R is 1.12 kΩ. If the contacts 106 of one group arranged in the b direction (that is, the contacts 106 of one group having the same coordinate indicating a position in the a direction) are targets, the difference between the maximum and minimum values of the combined resistance values R is 0.20 kΩ at most. Such differences in the combined resistance value R can lead to differences in convergence time required for the above potential fluctuation to converge between the respective positions wct.

For example, according to the calculation results of the combined resistance values R exemplified by FIG. 5, the difference between the maximum and minimum values of the combined resistance values R in the b direction is 0.20 kΩ, which is about ⅙ to ⅕ of that in the a direction. That is, the resistance value of the power wiring pattern 104 in the b direction is smaller than that of each power wiring pattern 105 in the a direction. As a result, the convergence time difference in the b direction is smaller than that in the a direction, and has a small influence on shading.

According to the above arrangement, the resistance value of the power wiring pattern 104 is smaller than that of each power wiring pattern 105 in the a direction. The power wiring patterns 104 and 105 may be provided such that the resistance value of the power wiring pattern 104 in the b direction is smaller than the combined resistance value of the plurality of power wiring patterns 105 in the a direction. According to this arrangement, the potential distribution of the well 102 in the b direction is made uniform. As a result, shading in the image acquired by the image capturing apparatus I1 is suppressed in the b direction and can mainly occur in the a direction. Therefore, shading correction in the a direction may just be performed for an image signal from the image capturing apparatus I1. Since the shading correction is only required to be performed with consideration in the a direction, the processing load is advantageously lower than when shading correction is performed with consideration in both the a direction and the b direction. In addition, the above arrangement can reduce the number of contacts 106 for providing potentials to the well 102, and allows the pixel array PA to be formed with a smaller area than when contacts are provided for the respective pixels 101. For the same reason, it is possible to ensure an area for the photoelectric conversion unit 202 of each pixel 101. Therefore, this embodiment is advantageous in facilitating shading correction processing while reducing the number of contacts. Note that when the power wiring patterns 104 and the power wiring patterns 105 are to be formed from the same material, the width of each power wiring pattern 104 is preferably larger than that of each power wiring pattern 105. With this arrangement, the resistance value of the power wiring pattern 104 in the b direction becomes smaller than that of each power wiring pattern 105 in the a direction. It is therefore possible to facilitate shading correction processing while reducing the number of contacts by forming the power wiring patterns 104 and the power wiring patterns 105 using the same material and making each power wiring pattern 104 have a larger width than each power wiring pattern 105.

Although the above description has exemplified the structure in which the total of two bonding pads 103 are arranged, the present invention is not limited to this arrangement. That is, the above shading may just be suppressed only in one direction, and one bonding pad 103 may be arranged on one of the upper and lower sides of the pixel array PA.

### Second Embodiment

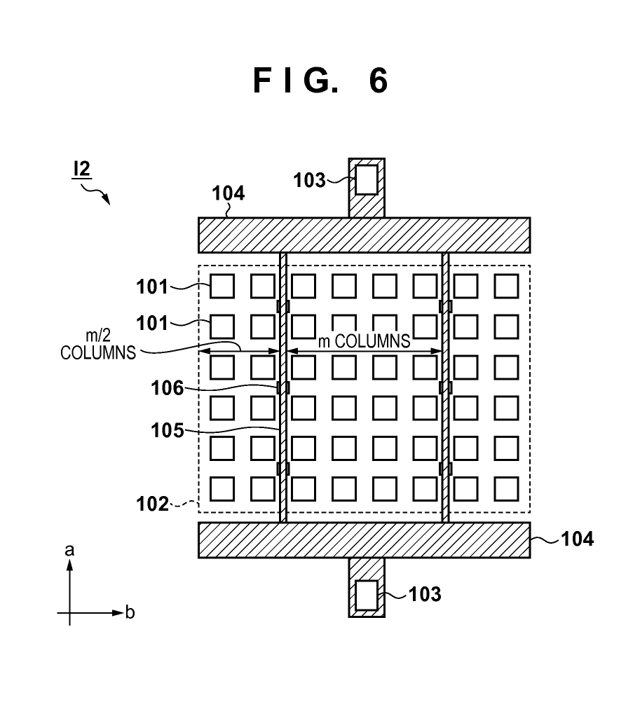

An image capturing apparatus 12 of the second embodiment will be described with reference to FIG. 6. The first embodiment has exemplified the arrangement in which the four power wiring patterns 105 are arranged for every two pixels. However, the present invention is not limited to this. Power wiring patterns 105 may just be arranged so as to equalize voltage supply loads on the respective power wiring patterns 105.

FIG. 6 exemplifies an arrangement in which the two power wiring patterns 105 are provided. If, for example, the distance between the power wiring patterns 105 corresponds to m pixel columns, the distance from one of the patterns to one end of a pixel array PA and the distance from the other pattern to the other end of the pixel array PA each may just be equal to m/2 pixel columns. With this arrangement, when, for example, pixel signals are read out from pixels 101 on a row basis, the respective power wiring patterns 105 supply voltages to a well 102 so as to compensate for a potential fluctuation of the well 102 which is caused by the driving of the m pixels 101. That is, the voltage supply loads on the respective power wiring patterns 105 are equal to each other. Although m=4 in this embodiment, this number can be changed, as needed, in accordance with the number of columns of the pixel array PA or the number of power wiring patterns 105.

According to the above arrangement, the respective power wiring patterns 105 are provided so as to equalize the voltage supply loads on them. This can suppress shading in the b direction. Therefore, the above arrangement can obtain the same effects as those of the first embodiment.

### Third Embodiment

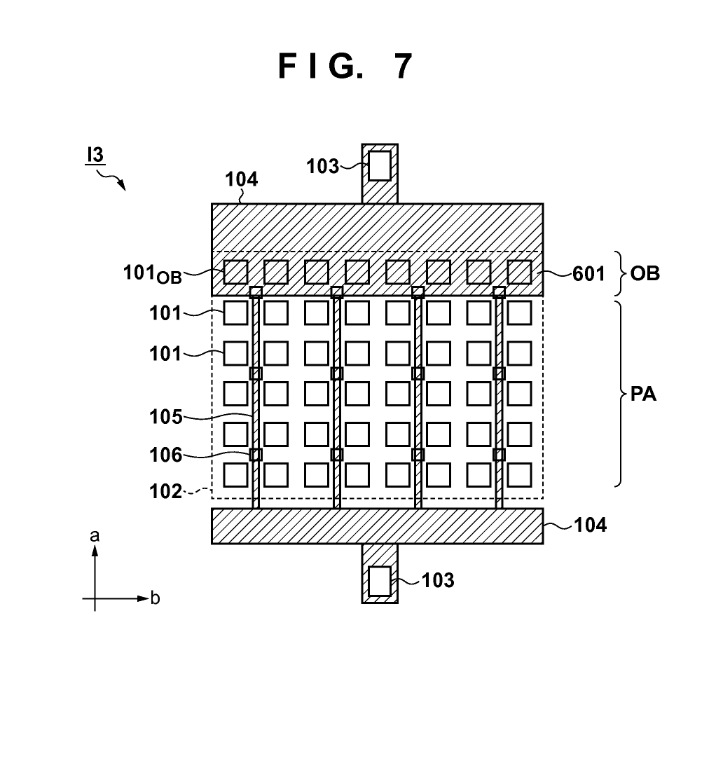

An image capturing apparatus 13 of the third embodiment will be described with reference to FIG. 7. This embodiment differs from the first embodiment in that an optical black pixel portion OB is provided outside a pixel array PA. A power wiring pattern 104 is arranged above the optical black pixel portion OB. This shields light entering each pixel 101_{OB}. A dark signal corresponding to a noise component is obtained from each pixel 101_{OB}.

The power wiring pattern 104 may be arranged at least partly above the optical black pixel portion OB. For example, the width (the width in the a direction) of the power wiring pattern 104 may be larger than that in the first embodiment so as to locate part of the power wiring pattern 104 immediately above the optical black pixel portion OB. This reduces a voltage drop at the power wiring pattern 104 in the b direction. That is, voltages at the respective positions on the power wiring pattern 104 in the b direction become almost equal to each other.

With the above arrangement as well, it is possible to obtain the same effects as those in the first embodiment. In addition, it is possible to make the power wiring pattern 104 also serve as a light-shielding member by arranging the power wiring pattern 104 above the respective pixels 101_{OB} of the optical black pixel portion OB.

Although the above description has exemplified the arrangement in which the optical black pixel portion OB is provided outside the pixel array PA, it can be said from another point of view that the pixel array includes both an effective pixel region and an optical black region. In this case, it can be regarded that the power wiring pattern 104 is arranged above a region outside the effective pixel region and also located above the optical black region.

### Fourth Embodiment

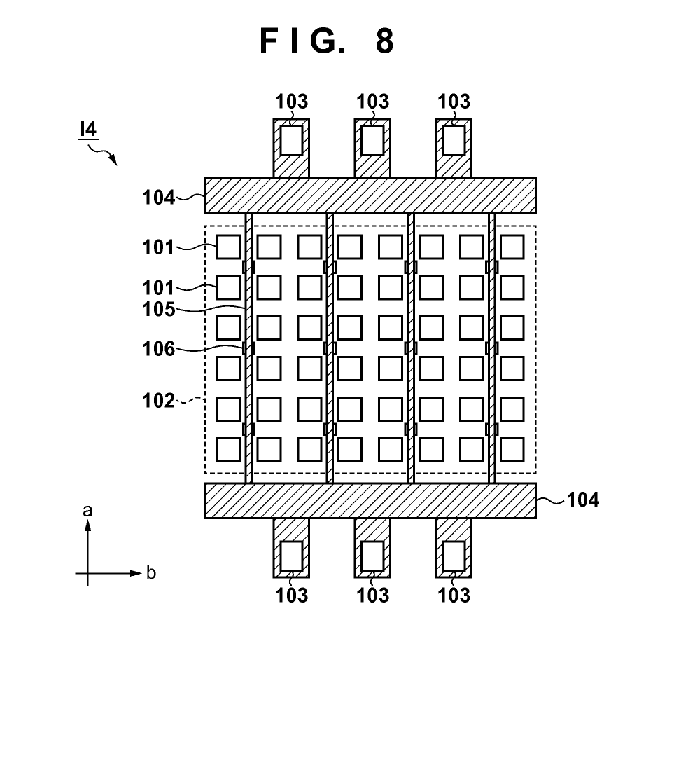

An image capturing apparatus 14 according to the fourth embodiment will be described with reference to FIG. 8. Each embodiment described above has exemplified the arrangement in which one bonding pad 103 is provided on each of the two opposing sides as a pad portion for receiving the reference voltage. However, the present invention is not limited to this. For example, a plurality of bonding pads 103 may be respectively provided on the two opposing sides. The respective bonding pads 103 are arranged along the b direction and electrically connected to power wiring patterns 104. This arrangement reduces a voltage drop at each power wiring pattern 104 in the b direction and makes voltages at the respective position on the power wiring pattern 104 in the b direction become almost equal to each other.

With the above arrangement, therefore, the same effects as those of the first embodiment can be obtained. In addition, arranging a plurality of pads along the b direction will suppress shading in the b direction. Although this embodiment has exemplified the arrangement in which three (a total of six) bonding pads 103 are arranged on each of the opposing sides, the number of bonding pads 103 is not limited to this.

Although the four embodiments have been described above, the present invention is not limited to them. The present invention can be changed, as needed, in accordance with objects, states, applications, functions, and other specifications, and can be implemented by other embodiments. Although, for example, each embodiment described above has exemplified the arrangement using an NMOS transistor as each transistor forming each pixel, a PMOS transistor may be used. In addition, although each embodiment described above has exemplified the arrangement configured to read out electrons of the charges generated and accumulated by the respective photoelectric conversion units, holes may be read out.

In addition, although the accompanying drawings show the power wiring patterns 104 wider than the power wiring patterns 105, each power wiring pattern 104 may be constituted by a plurality of line patterns arranged parallel to each other as long as the resistance values of these patterns have the above relationship. In this case, each line pattern may have a smaller width than each power wiring pattern 105. The respective line patterns may be provided on the same wiring layer or different wiring layers. Furthermore, these line patterns may be electrically connected to each other by using other line patterns extending in a direction to intersect with the line patterns.

In addition, when the power wiring patterns 104 are arranged along the row direction and the power wiring patterns 105 are arranged along the column direction as in each embodiment described above, each power wiring pattern 104 may be arranged above the signal readout unit described above. This arrangement is advantageous in supplying the necessary reference voltage to the signal readout unit. The column signal lines for signal readout which are connected to the signal readout unit may be arranged between the adjacent power wiring patterns 105. This can prevent crosstalk between the adjacent column signal lines. On the other hand, when each power wiring pattern 104 is to be arranged along the column direction and each power wiring pattern 105 is to be arranged along the row direction, the power wiring pattern 104 may be arranged above the driving unit described above, and the necessary reference voltage may be supplied to the driving unit. Control lines for supplying control signals from the driving unit may be arranged between the adjacent power wiring patterns 105. This can prevent crosstalk between the adjacent control lines.

(Image Capturing System)

The image capturing apparatus incorporated in an image capturing system typified by a camera or the like has been described above. Note that the concept of the image capturing system includes not only an apparatus mainly designed to perform image capturing but also an apparatus including an image capturing function as an auxiliary function (for example, a personal computer or a portable terminal). The image capturing system can include an image capturing apparatus according to the present invention, which has been exemplified as each embodiment described above, and a processing unit which processes signals output from the image capturing apparatus. This processing unit can include an A/D converter and a processor which processes the digital data output from the A/D converter.

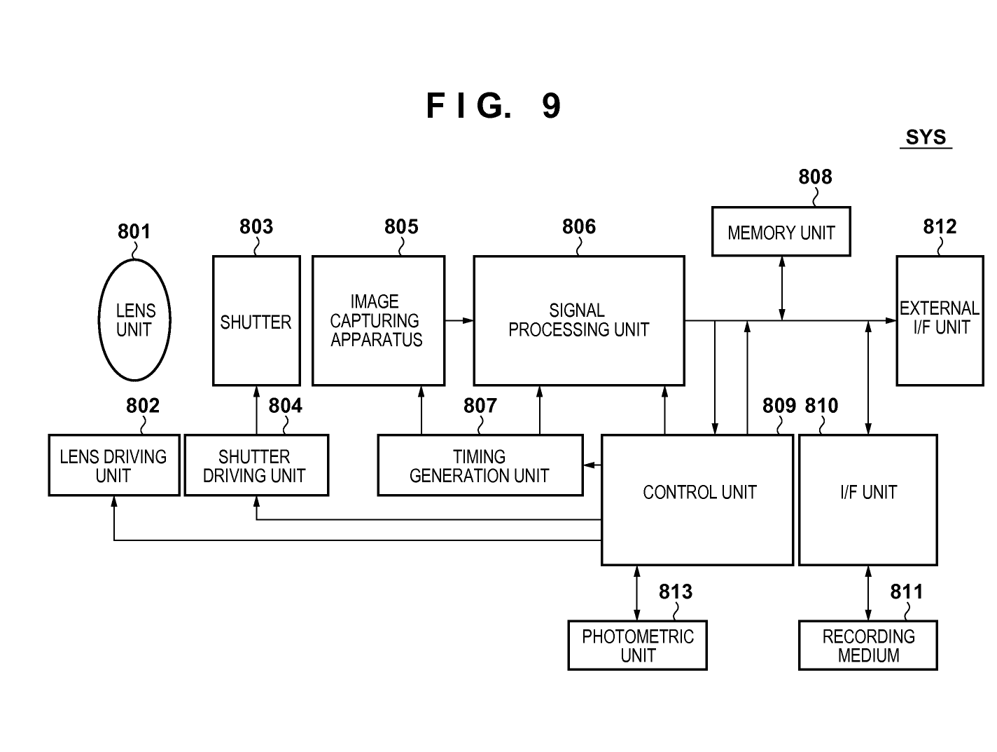

An example of the arrangement of an image capturing system SYS will be described with reference to FIG. 9. The image capturing system SYS includes a lens unit 801, a lens driving unit 802, a mechanical shutter 803, a shutter driving unit 804, an image capturing apparatus 805, a signal processing unit 806, a timing generation unit 807, a memory unit 808, and a control unit 809. The image capturing system SYS also includes an interface unit 810, a recording medium 811, an external interface unit 812, and a photometric unit 813.

The lens unit 801 forms an optical image of an object on the image capturing apparatus 805. The lens driving unit 802 performs zoom control, focus control, stop control, and the like for the lens unit 801. The shutter driving unit 804 drives the mechanical shutter 803. The image capturing apparatus 805 acquires an image signal representing the object image formed by the lens unit 801. The present invention is supplied to the image capturing apparatus 805. For example, the image capturing apparatus I1 described in the first embodiment can be used as the image capturing apparatus 805. The signal processing unit 806 includes, for example, a correction unit, and acquires image data by performing various types of correction processing (including the above shading correction) concerning the image signal obtained from the image capturing apparatus 805. In addition, the signal processing unit 806 can also perform compression processing for image data. The timing generation unit 807 generates various types of timing signals such as a clock signal, and outputs the signals to the image capturing apparatus 805 and the signal processing unit 806. The memory unit 808 temporarily stores image data and other types of information. The control unit 809 performs various types of computation processing, and controls the overall image capturing system SYS.

The interface unit 810 performs data communication with the recording medium 811, and performs, for example, storage processing for the image data. The recording medium 811 is a detachable memory unit such as a semiconductor memory, and stores image data or reads out stored image data via the interface unit 810. Image data is output to a display unit (not shown) via the external interface unit 812. The photometric unit 813 photometrically measures the luminance of the object.

After each power supply voltage is supplied to the image capturing system SYS to activate the image capturing system SYS, the control unit 809 calculates the distance from the object based on a signal from the image capturing apparatus 805 in response to the pressing of a release button (not shown). Subsequently, the lens driving unit 802 drives the lens unit 801 so as to focus an object. Although the above description has exemplified the case in which the distance from an object is calculated by using a signal from the image capturing apparatus 805, a distance measuring unit may be separately provided to calculate the distance. Subsequently, the image capturing system SYS starts an image capturing operation. When the image capturing operation is complete, the signal processing unit 806 processes an image signal from the image capturing apparatus 805, and the memory unit 808 stores the image data obtained by the resultant signal. The control unit 809 can save the image data, stored in the memory unit 808, in the recording medium 811 via the interface unit 810. In addition, the image data may be output to a display unit such as a display via the external interface unit 812, or output to a terminal such as a personal computer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-182475, filed Sep. 3, 2013, which is hereby incorporated by reference herein in its entirety.

What is claimed is:

1. An image capturing apparatus comprising:
a pixel array including a plurality of pixels arranged in a semiconductor region;
a pad portion configured to receive a reference voltage;
a plurality of first power wiring patterns, each being arranged on the pixel array along a first direction which is one selected from a row direction and a column direction of the pixel array;
a second power wiring pattern arranged on a region outside the pixel array along a second direction which is the other direction of the row direction and the column direction of the pixel array and configured to electrically connect the plurality of first wiring patterns respectively to the pad portion; and
a plurality of contacts configured to electrically connect the plurality of first power wiring patterns to the semiconductor region,
wherein a resistance value of the second power wiring pattern in the second direction is smaller than a resistance value of each of the plurality of first power wiring patterns in the first direction.

2. The apparatus according to claim 1, further comprising an optical black pixel portion arranged outside the pixel array,
wherein a first portion as at least part of the second power wiring pattern is arranged on the optical black pixel portion.

3. The apparatus according to claim 2, wherein the first portion functions as a light-shielding member configured to shield incident light.

4. The apparatus according to 1, further comprising a signal readout unit configured to read out a signal from the pixel array,
wherein a second portion as at least part of the second power wiring pattern is arranged on the signal readout unit.

5. The apparatus according to claim 1, further comprising a driving unit configured to drive the pixel array,
wherein a third portion as at least part of the second power wiring pattern is arranged on the driving unit.

6. The apparatus according to claim 1, wherein the pad portion includes a plurality of pads, the plurality of pads being arranged along the second direction and electrically connected to the second power wiring pattern.

7. The apparatus according to claim 1, further comprising a plurality of signal lines arranged along the first direction and configured to read out signals from the pixel array,
wherein each of the plurality of first power wiring patterns is arranged between two adjacent signal lines of the plurality of signal lines.

8. The apparatus according to claim 1, wherein the second power wiring pattern includes a plurality of line patterns arranged parallel to each other.

9. The apparatus according to claim 8, wherein the plurality of line patterns are connected to each other by using other line patterns arranged along the first direction.

10. An image capturing apparatus comprising:
a pixel array including a plurality of pixels arranged in a semiconductor region;
a pad portion configured to receive a reference voltage;
a plurality of first power wiring patterns, each being arranged on the pixel array along a first direction which is one selected from a row direction and a column direction of the pixel array;
a second power wiring pattern arranged on a region outside the pixel array along a second direction which is the other direction of the row direction and the column direction of the pixel array and configured to electrically connect the plurality of first wiring patterns respectively to the pad portion; and
a plurality of contacts configured to electrically connect the plurality of first power wiring patterns to the semiconductor region,
wherein the plurality of first power wiring patterns and the second power wiring pattern are formed from the same material and arranged on the same wiring layer, and
a width of the second power wiring pattern is larger than a width of each of the plurality of first power wiring patterns.

11. A camera comprising:
an image capturing apparatus defined in claim 1; and
a correction unit configured to correct shading which can occur in a direction corresponding to the first direction with respect to an image signal from the pixel array of the image capturing apparatus.

12. A camera comprising:
an image capturing apparatus defined in claim 10; and
a correction unit configured to correct shading which can occur in a direction corresponding to the first direction with respect to an image signal from the pixel array of the image capturing apparatus.
